(19) United States
(12) Patent Application Publication
(10) Pub. No.: US 2009/0038376 A1
(43) Pub. Date: Feb. 12, 2009

(54) GAS ANALYZER WITH A TRACE MOISTURE SENSOR

(76) Inventors: DIMITRY PETROSYAN, Island Lake, IL (US); Nikolay A. Petrosyan, Moscow (RU)

Correspondence Address: CARDINAL LAW GROUP, Suite 2000, 1603 Orrington Avenue, Evanston, IL, 60201, US

(21) Appl. No.: 11/834,436

(22) Filed: Aug. 6, 2007

(51) Int. Cl. G01N 25/56

(52) U.S. Cl. 73/25.04

(57) ABSTRACT

An apparatus for measuring moisture in a gas flowing in one direction through an enclosed chamber includes a moisture sensor placed in the chamber. The moisture sensor includes a first and second electrode supported by a non-conductive member. Each of the first and second electrode has at least one elongated finger and a coating made of a moisture absorbing material. At least one elongated finger of the first electrode is substantially parallel with at least one finger of the second electrode. The apparatus further includes a gas temperature sensor, a moisture sensor temperature sensor, and a cooling element for controlling the temperature of the moisture sensor based on the data from the gas temperature data and moisture sensor temperature data. Further, the apparatus includes a source of electrical current providing a voltage across the first and second electrode.

### TECHNICAL FIELD OF THE INVENTION

The invention relates to a method and apparatus for detecting moisture in a gas flow.

### BACKGROUND OF THE INVENTION

Faraday's law as applied to electrolysis is used to measure moisture in a gas. During electrolysis a specific amount of energy is needed to separate water molecules into hydrogen and oxygen. With the use of Faraday's law, the moisture content of the gas can be obtained by providing the electrical current and the mass rate of gas flow. The gas sensor in the prior art includes a chamber through which the gas with moisture in passed. Within the chamber is a non-conductive rigid support upon which rests two electrodes. The electrodes are coated with a moisture scavenging material to capture moisture. Electrolysis is carried out between the electrodes, electrolyzing the water in the coating.

For example, one prior solution discloses a sensor comprising a non-conductive cylindrical support with a circumferential surface supporting two helically wound platinum electrodes. Another attempt to measure moisture discloses a sensor comprising two electrodes with a multiple of staggered conductive fingers located in a planar support.

One problem that can occur with moisture sensors in the prior art is that there can be differences of the temperature between the sensor and the gas to be tested. Temperature differentials can result in less accurate testing results. Insulating various portions of the sensing apparatus fails to sufficiently improve results, as a low temperature differential does not necessarily result.

It is therefore an object of the invention to advance the art.

### SUMMARY OF THE INVENTION

One aspect of the invention includes an apparatus for measuring moisture in a gas. The apparatus includes at least a first chamber including a gas inlet and a gas outlet and a sensor positioned in the first chamber between the gas inlet and the gas outlet. The sensor has a substantially flat surface. The sensor includes a dielectric material plated with Tantalum. The Tantalum is at least partially coated with a layer of phosphorous pentoxide. Additionally, the apparatus includes at least one source of a voltage differential connected to the sensor, wherein the sensor senses the current flowing as a result of the voltage differential, and wherein the moisture in the gas is measured based on the flowing current.

Another aspect of the invention includes an apparatus for measuring moisture in a gas flowing in one direction through an enclosed chamber includes a moisture sensor placed in the chamber. The moisture sensor includes a first and second electrode supported by a non-conductive member. Each of the first and second electrode has at least one elongated finger and a coating made of a moisture absorbing material. At least one elongated finger of the first electrode is substantially parallel with at least one finger of the second electrode. The apparatus further includes a gas temperature sensor, a moisture sensor temperature sensor, and a heating element Thermoelectric (Peltier) Module for controlling the temperature of the moisture sensor based on the data from the gas temperature data and moisture sensor temperature data. Further, the apparatus includes a source of electrical current providing a voltage across the first and second electrode.

Another aspect of the invention provides a method of measuring moisture in a gas. The method includes flowing gas at a predetermined rate of flow though a chamber having a moisture sensing element with two electrodes, an entry opening, and an exit opening, measuring a gas temperature of the gas flow near the entry opening, and measuring a moisture sensor temperature of the moisture sensor. Additionally, the method includes adjusting the moisture sensor temperature based on the gas temperature and the temperature of the moisture sensor, providing a predetermined electrical current across the electrodes, and determining the moisture in the gas based upon the predetermined electrical current and the predetermined rate of gas flow.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a partial cross-sectional side view of the assembled apparatus, in accordance with one aspect of the invention;

FIG. 2 is a top view of the assembled apparatus, in accordance with one aspect of the invention;

FIG. 3 is a top view of the moisture sensor, in accordance with one aspect of the invention;

FIG. 4 is an enlarged partial perspective view of the moisture sensor, in accordance with one aspect of the invention; and

FIG. 5 is a flow chart of the method of operating the apparatus, in accordance with one aspect of the invention.

### DESCRIPTION OF THE PRESENTLY PREFERRED EMBODIMENTS

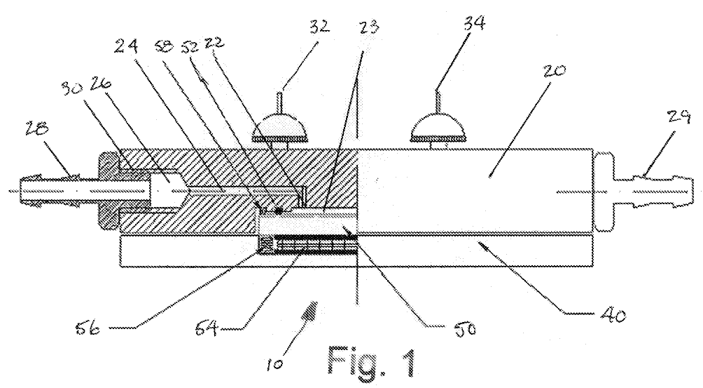

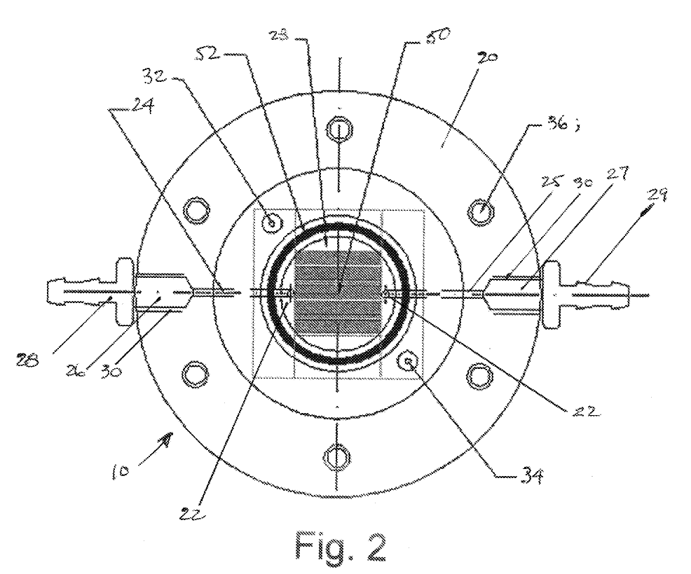

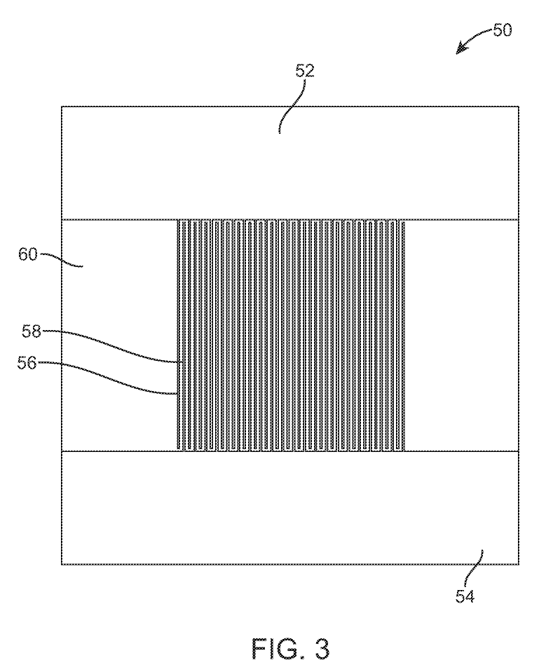

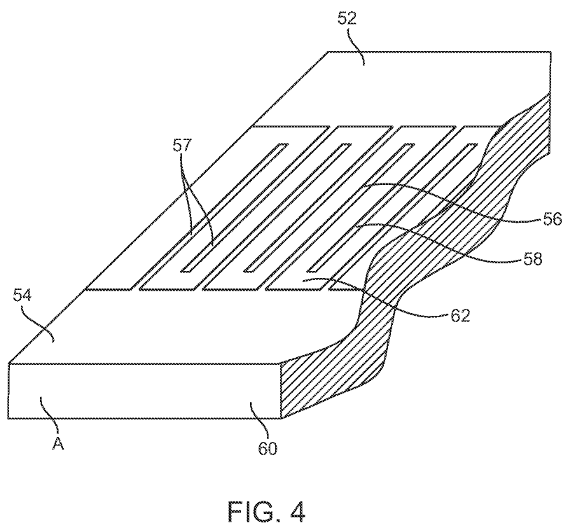

Referring to FIGS. 1 and 2, an apparatus 10 is shown generally. Apparatus 10 includes a cover 20, a base 40, a moisture sensor 50, and a Thermoelectric (Peltier) Module 54, and a temperature sensor 58. The moisture sensor 50 appears in more detail in FIGS. 3 and 4. FIG. 3 is a top view of the sensor and FIG. 4 shows an enlarged partial perspective view of the sensor. The sensor includes a non-conductive rigid plate 60 supporting a first electrode and a second electrode. Each electrode includes a base 52, 54 and a multiple of electrode fingers 56, 58. Over the fingers is a coating of a moisture scavenging material such as phosphorous pentoxide. Other such materials can include certain polymeric materials such as polyamide polymers. The phosphorous pentoxide is applied over the electrodes by coating the surfaces of the fingers with an aqueous solution of phosphoric acid followed by drying the surface of the sensor element under dry nitrogen to convert the phosphoric acid to phosphorous pentoxide

The fingers 56, 58 extend from respective electrode bases 52, 54. The electrode fingers and bases are supported by the non-conductive plate 60 (FIG. 3). The plate 60 can be made out of a hard dielectric material, such as quartz, ceramics, polymer, and others. The electrodes rest on a planar mounting surface 62 (FIG. 4) of the plate 60. The electrodes can be made from solid conductive material. In one embodiment, the electrodes include metal plating. One of a variety of methods of depositing conductive material on the non-conductive plate are available and can be used in the manufacture of the moisture sensor. For example, the conductive material can be sputter coated, dipped, or any appropriate vacuum deposition technique. Conductive materials used in the electrodes should have high corrosion resistance and can include platinum, tantalum or similar metals.

In one embodiment, the moisture sensor has plate dimensions of 25×25 millimeters with effective electrode work area dimensions of 12.7×12.7 millimeters. Electrodes in the effective electrolysis area have parallel fingers 56, 58 which are placed between one another in an “inter-digitized” manner. Each of the fingers is electrically coupled to the respective electrode base 52, 54, which bases are electrically coupled to respective first and second electrical terminals 32, 34. In one embodiment, the distance between two parallel fingers is 0.2 mm. In one embodiment, the width of each segment is 0.1 mm. Nevertheless, various dimensions can be used which will affect the sensor's electrical parameters.

Application of a substantially constant voltage to the sensor, such as the application of an electrical load to terminals, forms a field and results in electrolysis of moisture within the gas flow. The resulting electrolysis of the moisture affects the field. For example, when a constant voltage is applied to the sensor, and gas flow rate is 100 cc/minute, the field results in a current of 0.001 mA per 1 ppm (H20). Thus, the current corresponding to the “0” or “Dry Point” of the sensor is less than 0.001 mA, which is below the level of 1 ppm.

In one embodiment, the moisture sensor 50 includes a substantially flat design, allows the creation of very simple and inexpensive housings. Certain flat designs can also reduce the internal volume of the sensing chamber 25 shown in FIGS. 1 and 2.

In one embodiment, the cover 20 comprises stainless steel but does not have direct mechanical contact with any portion of the moisture sensor 50. A gasket or O-ring 52 made from insulative materials, such as rubber, is placed between the cover 20 and the moisture sensor 50. The gasket holds the top of the sensor in place while creating a chamber with the recess through which the gas is to pass in a direction between the openings 22 which openings are formed in the cover 20. In one embodiment, this chamber is 1.5-2.0 millimeters deep with a volume of less than 0.5 cc. Electrical terminals 32 and 34 pass through the cover to electrically couple the respective electrodes to a source of electricity.

The cover 20 contains conduits 24, 25 which respectively communicate with receptacles 26, 27 and openings 22. In one embodiment, receptacles 26, 27 have threaded grooves 30 which mate with threads of the nozzles 28, 29. In operation, the gas to be sampled flows through nozzle 28 of the receptacle 26 through conduit 24 and a first opening 22 and into the chamber 23. The gas flows in the chamber 23 generally between the two openings 22 in a direction “A” shown in FIG. 4. Thereafter, the gas flows through second opening 22 through conduit 25, through receptacle 27, and out nozzle 29. The shape of the chamber can affect the flow and turbulence within the chamber. In one embodiment, the chamber includes a substantially rectangular cross-section substantially perpendicular to the gas flow between the openings 22. Further, the chamber has a substantially round cross section substantially parallel to the planar mounting surface 62. A plurality of fasteners maintain the cover 20 and base 40 in position relative to each other. In one embodiment, the fasteners are placed through apertures 36.

System 10 further includes a gas temperature sensor disposed to sense the temperature of gas entering the device and a moisture sensor temperature sensor 58 disposed to sense the temperature of the moisture sensor. Each of the gas temperature sensor and moisture sensor temperature sensor are in communication with a controller configured to adjust the temperature of the moisture sensor via a heating or cooling element 54 (described below). In one embodiment, the gas temperature sensor is disposed remote from system 10, upstream from the moisture sensor. In one embodiment, the system 10 further includes a controller which controls the action of the heating/cooling element based upon the temperatures of gas and moisture sensors.

In addition, system 10 includes either a Thermoelectric (Peltier) Module. The cooling/heating element (Thermoelectric (Peltier) Module) 54 is thermally attached to the moisture sensor and operates based on a feedback loop from the gas temperature sensor and moisture sensor temperature sensor to adjust the temperature of the moisture sensor to be substantially equal to the gas temperature. In one embodiment, the Thermoelectric (Peltier) Module includes a heat sink. In another embodiment, the cooling/heating element includes a resistor configured to provide heat responsive to a current.

In certain embodiments, the system 10 further includes a thermo insulator 56. In certain embodiments, the thermo insulator 56 is installed around the cooling element 54 with a form mating with the outer perimeter of the Thermoelectric (Peltier) Module. In one embodiment, the Thermoelectric (Peltier) Module 54 is placed directly on the bottom surface of the moisture sensor. The gas temperature sensor may be placed in any location, but in one embodiment is located near the moisture sensor and, in one embodiment, is positioned for increased thermal contact with the inlet of the gas supply. A temperature controller generates an electrical signal. The polarity and voltage level of this signal are dependent on the difference between the gas temperature and the moisture sensor temperature. This signal is then applied to the cooler element, which in turn normalizes the temperature.

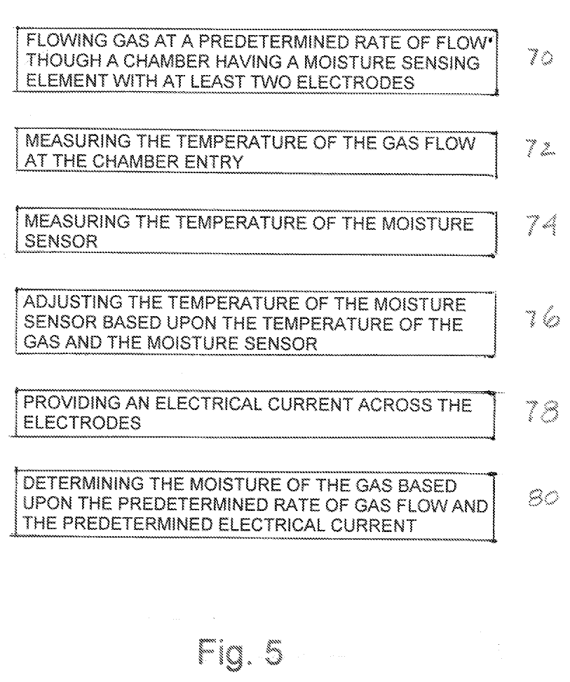

FIG. 5 illustrates one embodiment of a method for sensing moisture within a gas flow, in accordance with one aspect of the invention. The first step 70 provides the flow of gas to be measured at a predetermined rate of flow though a chamber having a moisture sensing element with two electrodes, an entry opening, and an exit opening. In step 72, the temperature of the gas flowing near the entry opening is measured. The temperature of the moisture sensor is measured in step 74. In step 76 the temperature of the moisture sensor is adjusted based upon the temperature of the gas and the temperature of the moisture sensor. Next in step 78 a predetermined electrical current is placed across the electrodes to begin electrolyzing process. In the final step 80 the moisture in the gas is determined based upon the predetermined electrical current and the predetermined rate of gas flow.

In one embodiment, the invention includes an apparatus for measuring moisture in a gas. The apparatus includes at least a first chamber including a gas inlet and a gas outlet and a sensor positioned in the first chamber between the gas inlet and the gas outlet. The sensor has a substantially flat surface. The sensor includes a dielectric material plated with Tantalum. The Tantalum is at least partially coated with a layer of phosphorous pentoxide. Additionally, the apparatus includes at least one source of a voltage differential connected to the sensor, wherein the sensor senses the current flowing as a result of the voltage differential, and wherein the moisture in the gas is measured based on the flowing current. In one embodiment, the apparatus further includes at least one thermoelectric element configured to adjust the temperature of the sensor to match the temperature of the gas entering the first chamber via the gas inlet. In one embodiment, the apparatus further includes at least a first electrode and a second electrode, wherein the first electrode and second electrode are substantially parallel with other. In one embodiment, the first electrode and second electrode are wound helically. In one embodiment, the chamber is defined by a housing, the housing including a cylindrical profile. In one embodiment, the apparatus further includes a thermal insulator between the sensor and the housing. In one embodiment, the apparatus further includes a gasket surrounding the chamber and defining a substantially gas-tight seal. In one embodiment, the gas flow between the gas inlet and gas outlet defines a gas flow axis and the chamber includes a substantially circular cross section along the gas flow axis. In one embodiment, the chamber includes a substantially rectangular first cross section substantially perpendicular to the gas flow axis. In one embodiment, the apparatus further includes a source of electrical current providing a voltage across the first electrode and second electrode such that the voltage is responsive to the difference between the sensed gas temperature and sensed moisture sensor temperature.

In one embodiment, the invention includes an apparatus for measuring moisture in a gas. The apparatus includes at least a first chamber including a gas inlet and a gas outlet and a sensor positioned in the first chamber between the gas inlet and the gas outlet. The sensor has a substantially flat surface. The sensor includes a dielectric material plated with niobium. The niobium is at least partially coated with a layer of phosphorous pentoxide. Additionally, the apparatus includes at least one source of a voltage differential connected to the sensor, wherein the sensor senses the current flowing as a result of the voltage differential, and wherein the moisture in the gas is measured based on the flowing current. In one embodiment, the apparatus further includes at least one thermoelectric element configured to adjust the temperature of the sensor to match the temperature of the gas entering the first chamber via the gas inlet. In one embodiment, the apparatus further includes at least a first electrode and a second electrode, wherein the first electrode and second electrode are substantially parallel with other. In one embodiment, the first electrode and second electrode are wound helically. In one embodiment, the chamber is defined by a housing, the housing including a cylindrical profile. In one embodiment, the apparatus further includes a thermal insulator between the sensor and the housing. In one embodiment, the apparatus further includes a gasket surrounding the chamber and defining a substantially gas-tight seal. In one embodiment, the gas flow between the gas inlet and gas outlet defines a gas flow axis and the chamber includes a substantially circular cross section along the gas flow axis. In one embodiment, the chamber includes a substantially rectangular first cross section substantially perpendicular to the gas flow axis. In one embodiment, the apparatus further includes a source of electrical current providing a voltage across the first electrode and second electrode such that the voltage is responsive to the difference between the sensed gas temperature and sensed moisture sensor temperature.

The design of the apparatus disclosed herein creates a relationship between the area of electrolysis and the overall area where the area of electrolysis is approximately 3.14 times greater that the whole area of the electrolyte surface. Because the width of the flat electrode is approximately 3.14 times shorter than the width of the round electrode. This allows for increased response speed, reduction in the current of “0” (dry point), decrease in the overall dimensions of the sensor, simple sensor housing, very small value of the measuring chamber, and easier temperature control.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. An apparatus for measuring moisture in a gas, the apparatus comprising:
at least a first chamber including a gas inlet and a gas outlet;
a sensor with a substantially flat surface, the sensor comprising a dielectric material plated with Tantalum, the Tantalum at least partially coated with a layer of phosphorous pentoxide, the sensor positioned in the first chamber between the gas inlet and the gas outlet;
at least one source of a voltage differential connected to the sensor, wherein the sensor senses the current flowing as a result of the voltage differential, and wherein the moisture in the gas is measured based on the flowing current.

2. The apparatus of claim 1 further comprising at least one thermoelectric element configured to adjust the temperature of the sensor to match the temperature of the gas entering the first chamber via the gas inlet.

3. The apparatus of claim 1 wherein the sensor comprises at least a first electrode and a second electrode, wherein the first electrode and second electrode are substantially parallel with other.

4. The apparatus of claim 3 wherein the first electrode and second electrode are wound helically.

5. The apparatus of claim 1 wherein the chamber is defined by a housing, the housing including a cylindrical profile.

6. The apparatus of claim 5 further including a thermal insulator between the sensor and the housing.

7. The apparatus of claim 1 further comprising a gasket surrounding the chamber and defining a substantially gas-tight seal.

8. The apparatus of claim 1, wherein the gas flow between the gas inlet and gas outlet defines a gas flow axis and wherein the chamber comprises a substantially circular cross section along the gas flow axis.

9. The apparatus of claim 8 wherein the chamber comprises a substantially rectangular first cross section substantially perpendicular to the gas flow axis.

10. The apparatus of claim 1 further comprising:
a source of electrical current providing a voltage across the first electrode and second electrode; the voltage responsive to the difference between the sensed gas temperature and sensed moisture sensor temperature.

11. A method of measuring moisture in a gas comprising the steps of:
flowing gas at a predetermined rate of flow though a chamber;
directing the gas over at least one sensor, the sensor comprising a substantially flat profile, and wherein the sensor comprises a dielectric coated with a layer of tantalum, and the layer of tantalum coated with a layer of phosphorus pentoxide;
providing a predetermined electrical current across the electrodes; and
determining the moisture in the gas based upon the predetermined electrical current and the predetermined rate of gas flow.

12. The method of claim 11 further comprising:
measuring a gas temperature of the gas flow near the entry opening;
measuring a moisture sensor temperature of the moisture sensor; and
adjusting the moisture sensor temperature based on the gas temperature and the temperature of the moisture sensor.

13. An apparatus for measuring moisture in a gas, the apparatus comprising:
at least a first chamber including a gas inlet and a gas outlet;
a sensor with a substantially flat surface, the sensor comprising a dielectric material plated with Niobium, the Niobium at least partially coated with a layer of phosphorous pentoxide, the sensor positioned in the first chamber between the gas inlet and the gas outlet;
at least one source of a voltage differential connected to the sensor, wherein the sensor senses the current flowing as a result of the voltage differential, and wherein the moisture in the gas is measured based on the flowing current.

14. The apparatus of claim 13 further comprising at least one thermoelectric element configured to adjust the temperature of the sensor to match the temperature of the gas entering the first chamber via the gas inlet.

15. The apparatus of claim 13 wherein the sensor comprises at least a first electrode and a second electrode, wherein the first electrode and second electrode are substantially parallel with other.

16. The apparatus of claim 15 wherein the first electrode and second electrode are wound helically.

17. The apparatus of claim 13, wherein the gas flow between the gas inlet and gas outlet defines a gas flow axis and wherein the chamber comprises a substantially circular cross section along the gas flow axis.

18. The apparatus of claim 17 wherein the chamber comprises a substantially rectangular first cross section substantially perpendicular to the gas flow axis.

19. The apparatus of claim 13 further comprising:
a source of electrical current providing a voltage across the first electrode and second electrode of the thermoelectric element; the voltage responsive to the difference between the sensed gas temperature and sensed moisture sensor temperature.
